(19) United States
(12) Patent Application Publication
(10) Pub. No.: US 2007/0136994 A1
(43) Pub. Date: Jun. 21, 2007

(54) HINGE ASSEMBLY FOR FLAT DISPLAY MONITOR

(75) Inventor: An-Kui Hu, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,439

(22) Filed: Aug. 4, 2006

(30) Foreign Application Priority Data
Dec. 1, 2005 (CN) 200510102108.2

(51) Int. Cl. E05D 11/08

(52) U.S. Cl. 16/340

(57) ABSTRACT

A hinge assembly (300) for use in a flat display monitor includes a support seat (10), a base seat (20) and a pivot mechanism. The support seat has a cutout (164) defined by two opposed side surfaces. The base seat includes a resisting member disposed thereon. The pivot mechanism rotatably connects the support seat to the base seat. A resisting member (94) on the base seat is movable in the cutout of the support seat upon rotating of the support seat relative to the base seat. The two side surfaces are configured to engage with the resisting member when the support seat rotates relative to the base seat in a manner so as to prevent the resisting member from moving further to limit a rotation angle between the support seat and the base seat.

### FIELD OF THE INVENTION

The present invention generally relates to hinge assemblies and, particularly, to a hinge assembly for a flat display monitor.

### DISCUSSION OF THE RELATED ART

With the widespread use and the variety of computers available, display devices configured for such a variety of computers also come in a wide range of sizes, shapes, and weight. In general, a typical cathode-ray tube (CRT) monitor includes a display panel for displaying an image, a vacuum tube coupled to the rear of the display panel, and an electron gun coupled to the rear of the vacuum tube. This configuration is a huge factor in limiting the total volume and final weight of the CRT monitor. In addition, the CRT monitor carries a huge problem in that a user is easily fatigued when looking at the CRT monitor over several hours due to its low image quality. It is this problem alone that many people switched to using a flat screen display monitor, e.g., liquid crystal display (LCD) monitor, from the conventional CRT monitors. Such flat display monitors generally offer the advantages of a greatly reduced size and weight properties including the ability to produce a high image quality. Furthermore, flat screen display monitors may help to overcome space limitations through folding over (such as with a laptop computer) or rotating (such as with a desktop monitor) so as to facilitate adjustment of the position thereof relative to the user.

The rotating or folding-over functions of the flat display monitor are realized with a hinge assembly. Such a hinge assembly includes an L-shaped fixed seat, a pivotal axle, and a number of oiled washers. The fixed seat has a retaining hole defined therein. The pivotal axle is pivotally connected with the fixed seat. The pivotal axle has a retaining shoulder formed at a middle portion thereof, a connecting end portion integrally formed at a first end of the retaining shoulder, and a fixing end portion integrally formed at a second end of the retaining shoulder. The connecting end portion of the pivotal axle extends through a retaining hole of the fixed seat along with the oiled washers, and then fastened by a fastening piece. The hinge assembly may realize a maximum inclination angle of the flat display monitor so that the LCD shall not over fold, over shifting a center of gravity, causing the LCD to fall over. However, in use, it needs to use great efforts to rotate the hinge assembly, since a greater force is exerted thereon. As a result, it is inconvenient for a user to operate the hinge assembly.

Therefore, a new hinge assembly is desired in order to overcome the above-described shortcomings.

### SUMMARY

In one embodiment thereof, a hinge assembly for use in a flat display monitor includes a support seat, a base seat and a pivot mechanism. The support seat has a cutout defined by two opposed side surfaces. The base seat includes a resisting member disposed thereon. The pivot mechanism rotatably connects the support seat to the base seat. A resisting member on the base seat is movable in the cutout of the support seat upon rotating of the support seat relative to the base seat. The two side surfaces are configured to engage with the resisting member when the support seat rotates relative to the base seat in a manner so as to prevent the resisting member from moving further to limit a rotation angle between the support seat and the base seat.

Other advantages and novel features will become more apparent from the following detailed description when taken in conjunction with the accompanying drawings.

### BRIEF DESCRIPTION OF THE DRAWINGS

Many aspects of the hinge assembly can be better understood with reference to the following drawings. The components in the drawings are not necessarily drawn to scale, the emphasis instead being placed upon clearly illustrating the principles of the hinge assembly. Moreover, in the drawings, like reference numerals designate corresponding parts throughout the several views.

FIG. 1 is an isometric view of an embodiment of a hinge assembly, as used in a flat display monitor;

FIG. 2 is an exploded, isometric view of the hinge assembly in FIG. 1;

FIG. 3 is an assembled, isometric view of t the hinge assembly in FIG. 2 viewed from a first direction;

FIG. 4 is similar to FIG. 3, but viewed from a second direction; and

FIG. 5 is a cut-away view taken along line V-V in FIG. 3.

### DETAILED DESCRIPTION OF THE EMBODIMENTS

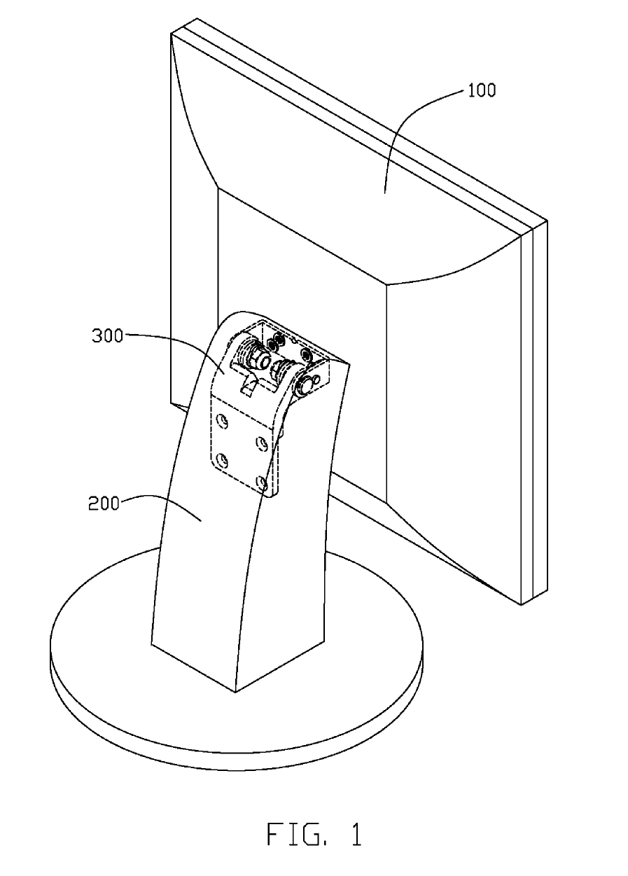

Referring to drawings in detail, FIG. 1 shows a flat display monitor employing a hinge assembly 300 in accordance with one embodiment of the present application. The flat display monitor is taken here as an exemplary application, for the purposes of describing details of the hinge assembly 300. It is to be understood, however, that the hinge assembly 300 could be advantageously used in other environments (e.g. cabinet doors). As such, although providing particularly advantages when used in flat display monitors, the hinge assembly 300 should not be considered limited in scope solely to an intended use environment of flats display monitors. The flat display monitor includes a display unit 100 and a support body 200. The hinge assembly 300 connects the display unit 100 to the support body 200 such that the display unit 100 can be pivoted relative to the support body 200.

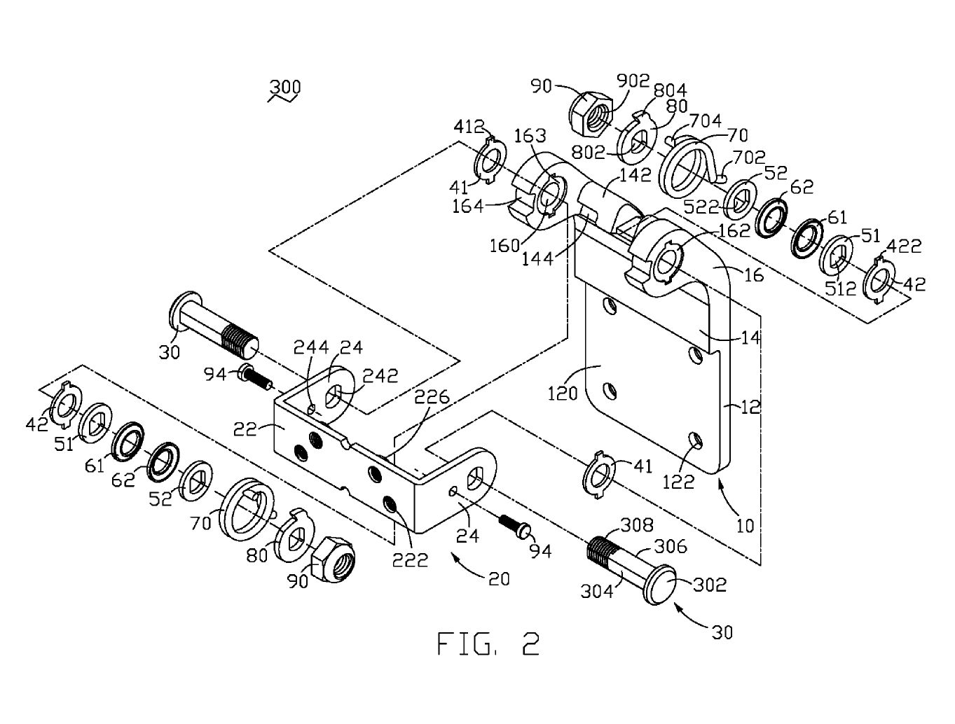

Referring to FIG. 2, the hinge assembly 300 includes a support seat 10, a base seat 20, and two pivot mechanisms (not labeled) each including a pivotal shaft 30, two tab washers 41 and 42, two washers 51 and 52, a pair of Belleville/cupped spring washers 61 and 62, a resilient element 70, a limiting washer 80, and a screw nut 90.

The support seat 10 includes a mounting portion 12, a connecting portion 14 and two extending portions 16. The mounting portion 12 and the connecting portion 14 are substantially boards with the connecting portion 14 being thicker than the mounting portion 12. The mounting portion 12 has a surface 120 and defines a plurality of mounting holes 122. In this embodiment, there are four mounting holes 122. The support seat 10 is mounted to the support body 200 by means of the mounting holes 122. One end of the connecting portion 14 is connected to the mounting portion 12 and an opposite end forms two protrusions 142. Each of the protrusions 142 is a triangular prism defining a fixing slot 144 on a side of the surface 120 of the support seat 10. The extending portions 16 extend at exterior sides of the protrusions 142 and are slanted toward the surface 120. The extending portions 16 are cylinders each defining a central pivoting hole 160 and a cutout 164 at a periphery thereof. One end of each extending portion 16 defines an end groove 162 and an opposite end of each extending portion 16 defines an end groove 163. Each extending portion 16 defines two opposite receiving slots (not labeled) adjacent to the end grooves 162 and 163.

The base seat 20 includes a fixing board 22 and two side boards 24 disposed at two ends of the fixing board 22. The fixing board 22 defines a plurality of threaded assembling holes 222. In this embodiment, there are four assembling holes 222. The base seat 20 is mounted to the display unit 100 by means of the assembling holes 222. The side boards 24 are formed on two opposite edges of the fixing board 22 perpendicularly extending outward. Each of the side boards 24 defines an engaging hole 242 and a threaded fixing hole 244. The engaging holes 242 are deformed, i.e., are non-round holes. Two bolts 94 are provided to screw into the fixing holes 244. Most of the bolts 94 extend between the two side boards 24.

The pivotal shaft 30 is substantially cylindrical in shape. The pivotal shaft 30 includes a bolt cap 302 and a bolt shaft 306. The bolt cap 302 is substantially a disk-like shape. The bolt shaft 306 defines a thread 308 on a distal end portion thereof opposite to the bolt cap 302. The bolt shaft 306 is flattened along a section of the curved surface area thus forming a flat surface 304. Thereby, the thread 308 is non-continuous and the section of the bolt shaft 306 corresponds to the shape and size of the engaging hole 242 of the base seat 20. The bolt shaft 306 passes through the engaging hole 242 of the base seat 20 and the pivoting hole 160 of the support seat 10.

The tab washers 41 and 42 are approximately ring-shaped. Two opposite tabs 412 are formed at a periphery of the tab washer 41, and two opposite tabs 422 are formed at a periphery of the tab washer 42. The tabs 412, 422 of the tab washers 41, 42 are configured to engage in the receiving slots of the extending portion 16 of the support seat 10.

The washers 51 and 52 are approximately ring-shaped. The washers 51 and 52 define a first latching hole 512 and 522 respectively. The latching holes 512 and 522 each has a shape and size corresponding to the engaging hole 242 of the base seat 20.

The Belleville washers 61 and 62 are plate-shaped. The Belleville washers are configured to provide an axial force. An amount of friction that helps the display unit 100 retain at any desired positions relative to the support body 200 is generated between the elements of the pivot mechanisms.

The resilient element 70 is a helical torsion spring having a first latching end 702 and a second latching end 704. The first latching end 702 extends along a radial direction of the resilient element 70 and the second latching end 704 extends along an axial direction. When the hinge assembly 300 is assembled, the resilient element 70 exerts a predetermined torsion force. A diameter of the resilient element 80 is larger than that of the tab washers 41 and 42, the washers 51 and 52, and the Belleville washers 61 and 62.

The limiting washer 80 is approximately ring-shaped. The limiting washer 80 defines a second latching hole 802. The second latching hole 802 has a shape and size corresponding to the engaging hole 242 of the base seat 20. The limiting washer 80 forms a limiting block 804 at its periphery. The limiting block 804 approximately extends along an involute of the limiting washer 80.

The screw nut 90 defines a thread 902 therein for engaging with the thread 308 of the bolt shaft 306 of the pivotal shaft 30.

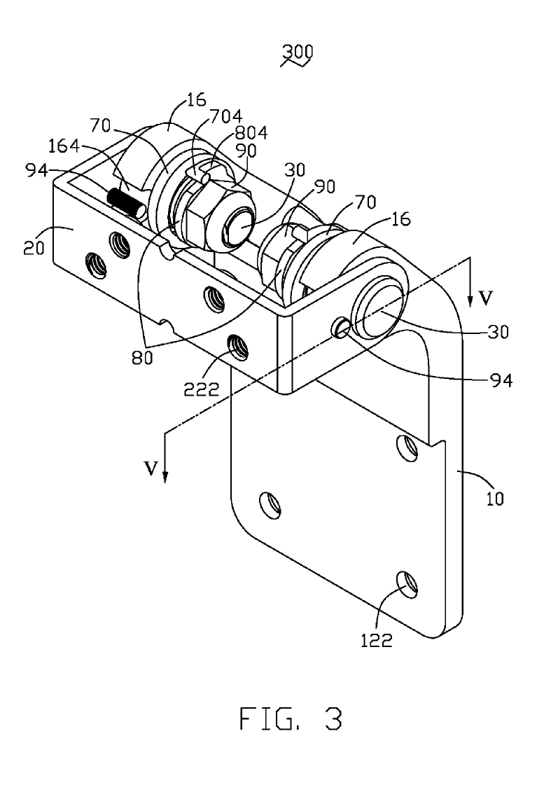

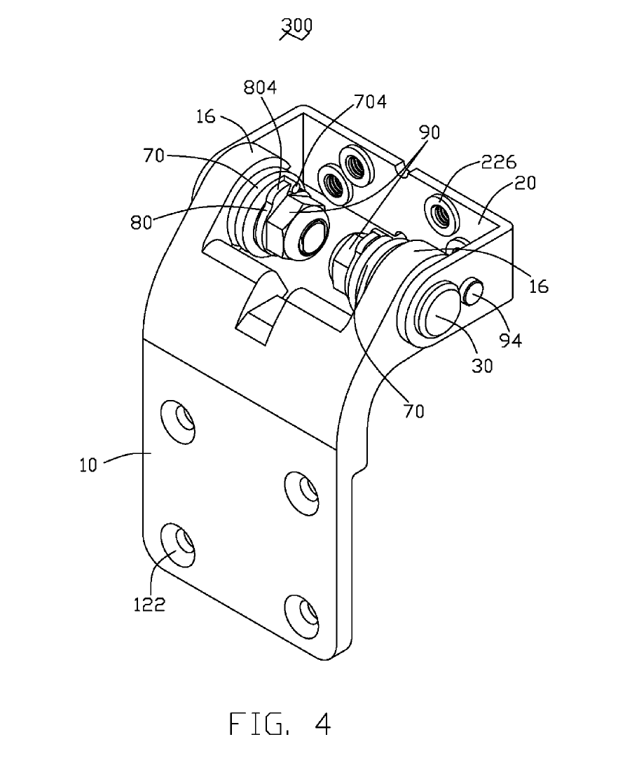

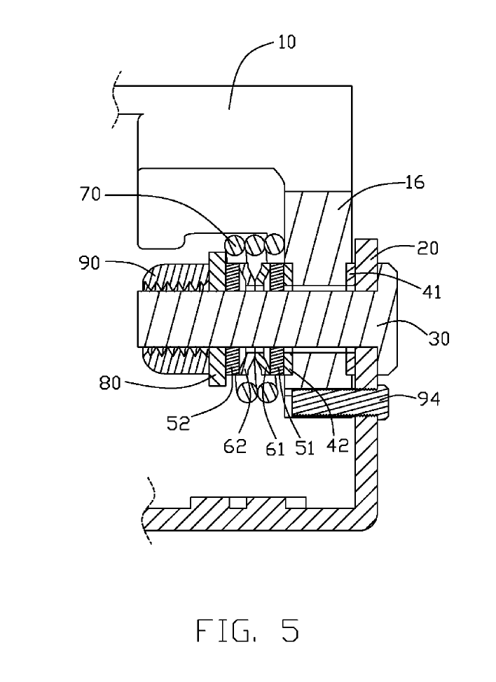

During assembly, referring now to FIGS. 3-5, the tab washers 41 and 42 are disposed in the end grooves 162 and 163 of the support seat 10. The tabs 412 and 422 of the tab washers 41 and 42 engage in corresponding receiving slots of the support seat 10 so as to make the tab washers 41 and 42 non-rotatable relative to the support seat 10. One resilient element 70 is placed around the bolt shaft 306 of each pivotal shaft 30 corresponding. The resilient element 70 has a predetermined torque force. The bolt shaft 306 of the pivotal shaft 30 passes through the engaging hole 242 of one side board 24 of the base seat 20, one tab washer 41, the pivoting hole 160 of one extending portion 16 of the support seat 10, one tab washer 42, one washer 51, two Belleville washers 61 and 62, one washer 52, and one limiting washer 80, in that order. The Belleville washers 61 and 62 are disposed opposite to each other. The first latching end 702 of the resilient element 70 is inserted into the fixing slot 144 of the support seat 10, the second latching end 704 of the resilient element 70 resists the limiting block 804 of the limiting washer 80. The screw nut 90 is fixed via the thread 308 of the pivotal shaft 30. The screw nut 90 is adjoined to the limiting washer 80. Thereby, a pivot mechanism is assembled. Another pivot mechanism is assembled in a similar manner. The bolts 94 are threaded in the fixing holes 244 of the base seat 20 and disposed in the cutout 164 of the support seat 10 so as to limit the rotation angle of the base seat 20 relative to the support seat 10. Therefore, a rotation angle of the display unit 100 relative to the support body 200 is limited in a desired scope.

After assembling, the tab washers 41 and 42, the washers 51 and 52, the Belleville washers 61 and 62, and the limiting washer 80 collaboratively maintain the desired spacing between the various portions of the pivot mechanism of the hinge assembly 300. Furthermore, the tab washers 41 and 42, the washers 51 and 52, the Belleville washers 61 and 62, and the limiting washer 80 together help provide an amount of friction that allows movement of the display unit 100 relative to the support body 200 upon application of a moderate force but that, otherwise, helps retain the desired position between the support body 200 and the display unit 100. Part of the required friction can be expected to be gained through the operation of the other elements of the hinge assembly 300, as well.

In use, a pushing force is exerted on the display unit 100, and, in turn, the display unit 100 causes the base seat 20 to likewise move. The washers 51 and 52 and the limiting washers 80 also rotate together with the base seat 20. Accordingly, the second latching ends 704 of the resilient elements 70 which resist the limiting blocks 804 of the limiting washers 80 rotate, whereby increase or decrease the torsion force of the resilient elements 70. Suppose that the display unit 100 is in a middle position, the torsion force of the resilient elements 70 increases when the display unit 100 rotates towards a first direction and the torsion force decreases when the display unit 100 rotates towards an opposite second direction. The support seat 10 is fixed relative to the support body 200. When the display unit 100 rotates through a determined angle toward the first direction or a determined angle toward the second direction, the bolts 94 fixed relative to the base seat 20 resists a wall defined in the cutout 164 of the support seat 10. Thereby, the display unit 100 together with the base seat 20 cannot rotate further. The tab washers 41 disposed between the support seat 10 and the base seat 20 may decrease the abrasion between the support seat 10 and the base seat 20 so as to prolong the use life.

In alternative embodiments, the pivotal shaft 30 is fastened, e.g., by means of other holding members such as a rivet or by a ring. In this manner, a C-shaped ring and a receiving groove for example, replace the screw nut 70 and the thread 308 of the bolt shaft 306. Only a single pivot mechanism may be provided. Accordingly, the extending portion 16 of the support seat 10, the side board 24 of the base seat 20 and the bolt 94 may also exist singularly. The cutout 164 may be omitted, and instead, a first resisting portion and a second resisting portion are formed on the support seat 10. The support seat 10 may be a single piece without extending portions 16. The bolt 94 may be replaced by other resisting members such as a pin or a protrusion formed on the base seat 20. Other elastic members such as springs or other elastic washers may replace the Belleville washers 61, 62. The support seat 10 may be mounted to the display unit 100, and accordingly the base seat 20 may be mounted to the support body 200.

As described above, the preferred embodiments provides a hinge assembly 300 for devices such as a flat display screen, which is convenient for a user to operate and durable. It is, however, to be understood that the hinge assembly 300 could potentially be useful in other applications (e.g., a free-standing, adjustable mirror) in which it may be desirable to allow selective pivoting over a limited angular range.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A hinge assembly, comprising:
a support seat defining a pivoting hole and a cutout;
a base seat defining an engaging hole, a resisting member fixedly disposed on the base seat for engaging in the cutout of the supporting seat; and
a pivot mechanism for rotatably connecting the support seat to the base seat, the pivot mechanism comprising:
a plurality of washers;
a resilient element residing between the support seat and the base seat for providing a torsion force;
an elastic member for providing an axial force;
a pivotal shaft fixedly connected to the base seat, the washers, the resilient element and the elastic member surrounding the pivotal shaft; and
a holding member disposed on the pivotal shaft to prevent the washers and the elastic member from disengaged with the pivotal shaft.

2. The hinge assembly as claimed in claim 1, wherein the base seat includes a fixing board and at least one side board disposed at one end of the fixing board, the engaging hole is defined in the side board and is deformed.

3. The hinge assembly as claimed in claim 2, wherein the resisting member is a bolt, the side board of the base seat defines a threaded fixing hole for fixedly receiving the bolt, most of the bolts extend to an inward side of the side board.

4. The hinge assembly as claimed in claim 2, wherein the washers comprise two tab washers disposed at two sides of the support seat, two washers disposed at two sides of the elastic member and a limiting washer, the elastic member comprises two elastic washers disposed opposite to each other.

5. The hinge assembly as claimed in claim 4, wherein the pivotal shaft comprises a bolt cap and a bolt shaft, the bolt cap is disposed at one end of the pivotal shaft and the bolt shaft is disposed at an opposite end, the bolt shaft is flattened to form a flat surface for making the section of the bolt shaft correspond to the shape and size of the engaging hole of the base seat.

6. The hinge assembly as claimed in claim 5, wherein the bolt shaft of the pivotal shaft defines a thread on a distal end portion thereof opposite to the bolt cap, the holding member is a screw nut to engage with the thread of the pivotal shaft.

7. The hinge assembly as claimed in claim 4, wherein the support seat includes a mounting portion, a connecting portion and an extending portion, the mounting portion and the connecting portion are substantially boards, one end of the connecting portion is connected to the mounting portion and an opposite end forms a protrusion, the protrusion defines a fixing slot, the extending portion is cylinder-shaped, the pivoting hole is defined in the extending portion and the cutout is defined at a periphery thereof.

8. The hinge assembly as claimed in claim 7, wherein two ends of the extending portion of the support seat each defines an end groove, the end grooves each has two opposite receiving slots, the tab washers are approximately ring-shaped and are disposed in the end grooves, two opposite tabs are formed at a periphery of each tab washer to engage with the receiving slots of the extending portion of the support seat.

9. The hinge assembly as claimed in claim 4, wherein the washers are approximately ring-shaped, the washers respectively define a first latching hole, the first latching holes each has a shape and size corresponding to the engaging hole of the base seat, the elastic washers are plate-shaped.

10. The hinge assembly as claimed in claim 7, wherein the limiting washer is approximately ring-shaped, the limiting washer defines a second latching hole, the second latching hole has a corresponding shape and size to the engaging hole of the base seat, the limiting washer forms a limiting block at its periphery.

11. The hinge assembly as claimed in claim 10, wherein the resilient element is a helical torsion spring having a first latching end and a second latching end, the first latching end of the resilient element is inserted into the fixing slot of the support seat, the second latching end of the resilient element resists the limiting block of the limiting washer.

12. A hinge assembly, comprising:
a support seat having a cutout defined by two opposed side surfaces;
a base seat including a resisting member disposed thereon; and
a pivot mechanism rotatably connecting the support seat to the base seat; and
wherein the resisting member on the base seat is movable in the cutout of the support seat upon rotating of the support seat relative to the base seat, the two side surfaces are configured to engage with the resisting member when the support seat rotates relative to the base seat in a manner so as to prevent the resisting member from moving further to limit a rotation angle between the support seat and the base seat.

13. The hinge assembly as claimed in claim 12, wherein the pivot mechanism comprises two tab washers, two washers, two elastic washers providing axial force, a resilient element providing torsion force, a holding member and a pivotal shaft, the resilient element resides between the support seat and the base seat, the tab washers, the washers, the elastic washers and the resilient element surrounding the pivotal shaft, the holding member is disposed on the pivotal shaft to prevent the washers and the elastic member from falling off from the pivotal shaft.

14. The hinge assembly as claimed in claim 13, wherein the two tab washers are disposed at two sides of the support seat, the elastic washers are disposed back to back, two washers are disposed at two sides of the elastic washers.

15. The hinge assembly as claimed in claim 12, wherein the base seat includes a fixing board and at least one side board disposed at one end of the fixing board, the side board defines an engaging hole which is deformed and a threaded fixing hole for fixedly receiving the resisting member, most of the resisting member extend to an inward side of the side board.

16. The hinge assembly as claimed in claim 14, wherein the pivotal shaft comprises a bolt cap and a bolt shaft, the bolt cap is disposed at one end of the pivotal shaft and the bolt shaft is disposed at an opposite end to engage with the holding member, the bolt shaft is flattened to form a flat surface for making the section of the bolt shaft corresponding to the shape and size of the engaging hole of the base seat.

17. The hinge assembly as claimed in claim 16, wherein the support seat includes a mounting portion, a connecting portion and an extending portion, the mounting portion and the connecting portion are substantially boards, one end of the connecting portion is connected to the mounting portion and an opposite end forms a protrusion, the protrusion defines a fixing slot, the extending portion is cylinder-shaped, a pivoting hole is defined in the extending portion and the cutout is defined at a periphery of the extending portion.

18. The hinge assembly as claimed in claim 17, wherein pivot mechanism further comprises a limiting washer forming a limiting block, the resilient element is a helical torsion spring having a first latching end and a second latching end, the first latching end of the resilient element is inserted into the fixing slot of the support seat, the second latching end of the resilient element resists the limiting block of the limiting washer.

19. A display monitor comprising:
a first seat including a first resisting portion and a second resisting portion spaced from each other;
a second seat rotatably mounted to the first seat, the second seat including a resisting member thereon; and
a display unit fixedly attached to one of the first and second seats;
wherein the first seat is rotatable relative to the second seat between a first position where the resisting member abuts against the first resisting portion, and a second position where the resisting member abuts against the second resisting portion.

20. The display monitor of claim 19, wherein the first seat is a single piece.
